(19) United States
(12) Patent Application Publication
(10) Pub. No.: US 2002/0085446 A1
(43) Pub. Date: Jul. 4, 2002

(54) Reactor vessel array

(75) Inventors: Peter John Van Den Brink, Amsterdam (NL); Mark Crocker, Amsterdam (NL); Bashir Husein Harji, Cottenham (GB); Thomas Maschmeyer, Delft (NL); Jan Cornelis Van Der Waal, Amsterdam (NL)

Correspondence Address: Salvatore J. Abbruzzese, HOFFMANN & BARON, LLP, 6900 Jericho Turnpike, Syosset, NY, 11791, US

(73) Assignee: Avantium International B.V.

(21) Appl. No.: 10/027,752

(22) Filed: Dec. 20, 2001

Related U.S. Application Data
(63) Continuation of application No. PCT/GB00/02501, filed on Jun. 23, 2000.

(30) Foreign Application Priority Data
Jun. 25, 1999 (EP) 99305017.8

(51) Int. Cl. B01F 11/00

(52) U.S. Cl. 366/118

(57) ABSTRACT

An apparatus for performing physical and/or chemical operations is provided. The apparatus includes a holding means (3) provided with openings (2) for an array of reactor vessels (1); reactor vessels (1) positioned totally or partly within the openings (2), and connection means (5) capable of connecting the reactor vessels (1) and the holding means (3), which connection means (5) are located on or in the holding means (3) surrounding the openings (2) in which the reactor vessels (1) are positioned. Processes which can be carried out with the apparatus include, inter alia, mixing, cooling, heating, centrifugation, evaporation, filtration and pressure processes.

### CROSS-REFERENCE TO RELATED APPLICATION

This is a continuation application of PCT/GB00/02501 filed Jun. 23, 2000, which PCT application claims priority of European patent application number 99305017.8 filed Jun. 25, 1999, herein incorporated by reference.

### FIELD OF THE INVENTION

The present invention is related to a reactor vessel array in which a number of (different) physical and/of chemical operations can be performed, either simultaneously or sequentially.

### BACKGROUND OF THE INVENTION

The desire to perform a multitude of operations in a short time is well known to those skilled in the art and a number of systems have been proposed, some of which are commercially available, to decrease the time in which, and possibly the size or scale on which, physical and/or chemical operations have to be performed. Reference is made, for instance, to the CombiTec system introduced by Argonaut Technologies in which use is made of the so-called Reactor Cassette.

One of the problems still remaining in this rapidly-growing area of technology is how to carry out operations either at elevated temperature and/or pressure and/or which require the handling of reactive components, possibly also at elevated temperatures and/or pressures. It has already been proposed in WO98/36826 (Sinvent AS) to use multi-autoclaves for the combinatorial synthesis of zeolites and other materials. The proposed system uses a central block containing a number of separated chambers provided with top and bottom plates and closing mechanisms which can be integrated with the central block.

WO-A-98/56 506 relates to systems and methods for parallel synthesis of compounds.

WO-A-98/17 391 describes a vessel handling system useful for combinatorial chemistry.

EP-A-0 916 397 discloses an apparatus and method used in multiple, simultaneous synthesis of general compounds.

GB-A-2 291 820 describes a gripping apparatus based on loop of pressure modified tubing.

WO-A-99/24 160 relates to a device for holding reaction vessels which can be thermally adjusted and agitated.

### SUMMARY OF THE INVENTION

Despite all efforts thus far, there is still much room for improvement, in particular with respect to the limited flexibility of the current systems. Also, further developments to increase the multi-functionality of such multi-reactor systems could well contribute to improved performance.

It has now been found that excellent results are obtained when using an improved apparatus as described hereinbelow. The present invention is an apparatus for performing physical and/or chemical operations comprising holding means provided with openings for an array of reactor vessels; reactor vessels positioned totally or partly within the openings, and connection means capable of connecting the reactor vessels and the holding means, which connection means are located on or in the holding means at the openings in which the reactor vessels are positioned, wherein the connection means are reinforced by the presence of a support plate containing openings having diameters substantially matching the diameters of the openings in the holding means and being removably fitted to the holding means.

In this basic concept, an array of any number of reactor vessels, e.g. 4, 6, 12, 24 of even 100 or more, can be held in position and subjected to any number of physical and/or chemical operations which are normally carried out in single reactor vessels. The reactor vessels can have any length provided they can be held in place in the holding means. Since the available reactor volume is of great importance it is one of the advantages of the present apparatus that the reactors can also be longer than the height of the holding means carrying the openings encompassing the reactor vessels. The vessels can be shorter, equal to or longer than the height of the holding means. Preference is given to reactor vessels protruding through the bottom of the holding means as this allows maximum flexibility in reactor volume which is highly desirable in short-time, multiple operations. The length of the reactor vessels is determined to some extent by the support capacity provided by the holding/connection means. It will be appreciated that, in conventional multi-autoclave systems, the bottom of the central block also serves as support for the reactors.

The holding means can be composed of any material compatible with the physical and/or chemical operations to be performed, i.e. wood, glass, plastic, steel or the like. Preference is given to holding means composed of steel. Those skilled in the art will know how to choose the material depending on the nature of the operation(s) to be performed. Another advantage of the holding means forming part of the apparatus according tot the present invention is that they can be rather short compared with the length of the reactor vessels they are holding, taking into account the strength of the connection means. It is also possible to use reactor vessels having different shapes, or shapes differing form conventional tubular models, for those parts of the reactor vessels positioned outside the openings in the holding means. For instance, the reactor vessels may be flasks of conical or spherical shape having their necks fitting the openings in the holding means. This increases the flexibility of the reactor vessel array according to the present invention. It will be clear that, when non-tubular reaction vessels are used which are longer than the height of the holding means, they have to be positioned form below the holding means or, if fitted in from above, require the holding means to be turned upside down prior to use.

If desired, the reactor vessels may be provided with inert linings which can either form an integral part of the insides of the reaction vessels or can be in the form of removable linings, for instance, linings made of (chemically) inert materials such as glass or plastics. If the reactor wall is made of steel, for instance, then an inert lining will be useful to prevent contact between aggressive components and the wall. For instance, when corrosive materials like hydrochloric acid have to be placed in steel vessels (because of pressure requirements), an inert lining will be used to protect the reactor wall.

The connection means are preferably located in recesses which are present at the surface or in the holding means. The recesses are adapted to receive gaskets which provide the actual connection. Suitably, the gaskets are present in recesses located at the surface of the holding means. Good results have been obtained by using O-shaped rings, in particular using O-shaped rings protruding partially above the surface of the holding means.

Alternatively, or in addition, recesses can be provided below the surface of the holding means, in which case the gaskets received therein may protrude into the openings in which the reactor vessels will be positioned. Alternatively, the recesses may be formed by holding means consisting of two layered plates. One of these may contain the recesses, whilst the other serves as a support. Alternatively, the tow layered plates may together provide the recesses when placed on top of each other.

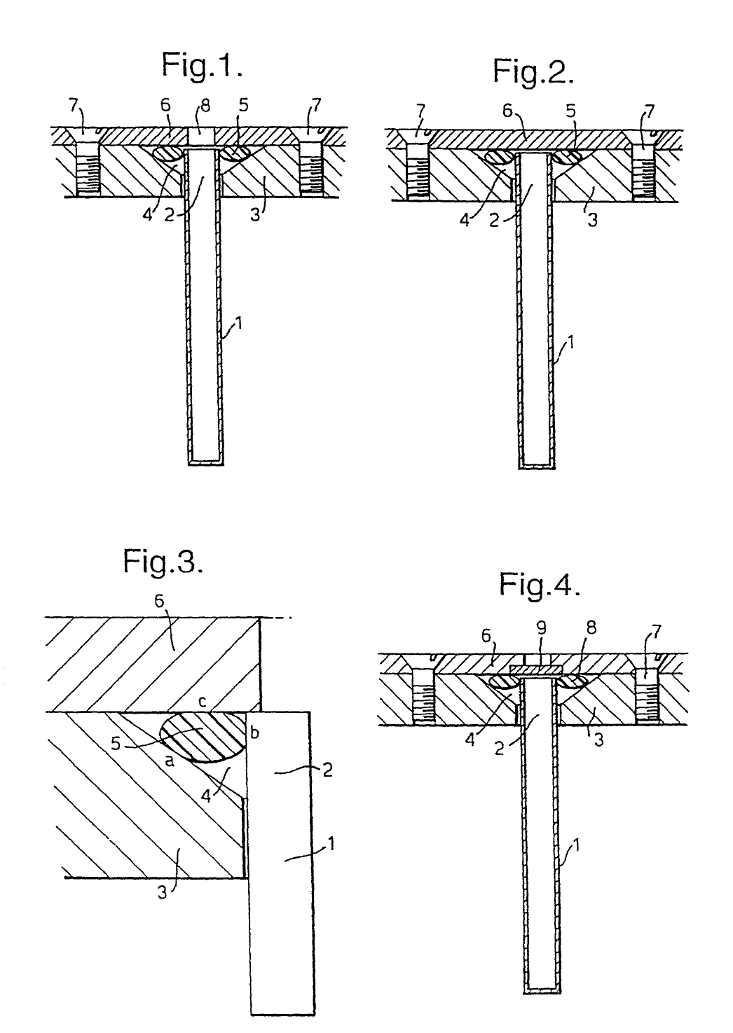

The invention will now be particularly described by way of example only with reference to the following, non-limiting Figures. For ease of reference, only (part of) one member of a reactor vessel array has been depicted in FIGS. 1-6. It should be understood that such a member forms part of any desired array, e.g. a 2×3, a 4×6 or a 10×10 array. Those skilled in the art will understand how to extrapolate the one member drawing to the appropriate array.

### BRIEF DESCRIPTION OF THE DRAWINGS

In FIG. 1, a basic arrangement of a reactor vessel, a holding plate and connection means is depicted for an embodiment in which an additional support plate is present.

In FIG. 2, an embodiment is depicted in which a solid support plate is present.

In FIG. 3, a more detailed view of the leak-tight configuration of the connection means is depicted.

In FIG. 4, an embodiment is depicted in which the reactor vessel is closed with a septum.

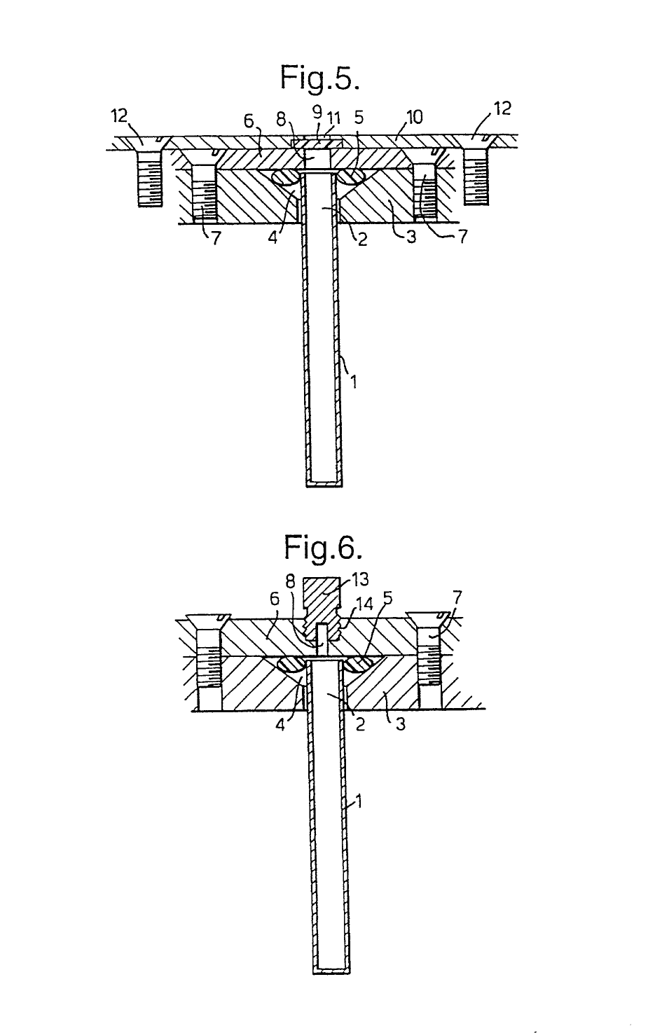

In FIG. 5, an embodiment is depicted in which a support plate and a cover plate form part of the array.

In FIG. 6, an embodiment is depicted in which a pressure relief valve is provided.

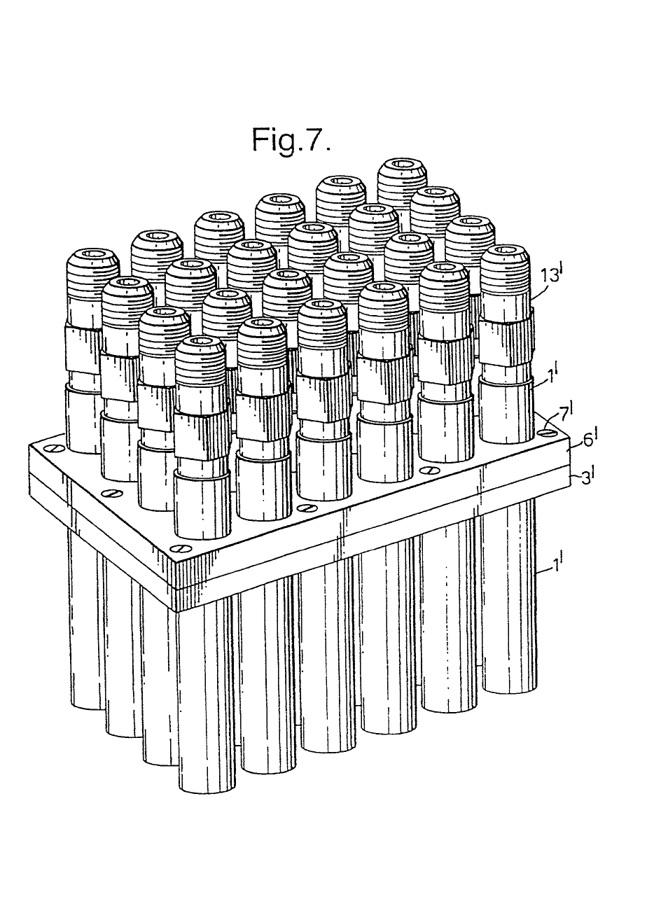

In FIG. 7, a general view of an array of 24 reactor vessels, each provided with a pressure relief valve, is depicted.

For ease of reference, similar parts in the various drawings are numbered identically.

### DESCRIPTION OF THE PREFERRED EMBODIMENT

In FIG. 1, a reactor vessel 1 is shown positioned in an opening 2 of a holding means 3. Holding means 3 is in the form of a plate which has a tapered recess 4 surrounding the opening 2. Connection means 5 is in the form of an O-ring which is positioned within the recess 4 and which, in the absence of rector vessel 1, slightly protrudes into the opening 2. By virtue of its resilience, connection means 5 tightly surrounds reactor vessel 1 when the reactor vessel is present in the holding means 3. The length of the reactor vessel 1 is not critical as long as it is held appropriately by the holding means 3. If desired, the connection means 5 can be supported by a support plate 6 which is fastenable to the holding means 3 by means of screw-threaded fasteners 7 having a screw thread which is complementary to a screw thread provided in holes in the holding means 3. Other forms of fastening, e.g. by clamps or bands, can also be applied. In this Figure the support plate 6 has an opening 8 overlying the opening 2 of holding means 3.

In FIG. 2, an embodiment is depicted in which the support plate 6 integrally supports the connection means 5. In this arrangement, the support plate 6 is a solid support plate without apertures overlying the openings 2, provided with screw-threaded fasteners 7 to fasten it to the holding means 3.

In FIG. 3, a more detailed view is given of the leak-tight sealing obtained by using the O-ring and the support plate 6. The three areas of contact (a, b and c) ensure a leak-tight connection between the O-ring, the reactor vessel 1 and the support plate 6.

In FIG. 4, an embodiment is depicted in which the top of the reactor vessel 1 is secured by a septum 9. This is held in place by the support plate 6 having an opening 8 (as depicted in FIG. 1) in which septum 9 is positioned. It is possible to provide a space at the part of the support plate 6 facing the surface of the holding means 3 in which the edges of septum 9 protrude (and reinforce the leak-tight connection when support plate 6 is fastened to the holding means 3).

In FIG. 5, an embodiment is depicted in which a cover means 10 (in the form of a cover plate) is positioned over the support plate 6. Cover means 10 has an opening 11, the diameter of which matches the diameter of the opening 2 of holding means 3. Septum 9 is positioned in the opening 11. It is possible to provide a space at the part of the cover plate 10 facing the surface of the holding means 3 in which the edges of septum 9 protrude and further reinforce the leak-tight connection when cover plate 10 is fastened to the holding means 3, for instance by screw-threaded fastenings 12 fitting holes in the holding means 3.

In FIG. 6 an embodiment is depicted in which, instead of septum, a pressure relief valve 13 is positioned at the top of the reactor vessel. The reactor vessel 1 is positioned in the opening 2 of holding plate 3 which has a tapered recess 4 surrounding opening 2. The connection means 5 is in the form of an O-ring which is positioned within the recess 4. The leak-tight connection is provided by support plate 6 which is fastened to holding means 3 by means of screw-threaded fasteners 7. Support plate 6 is provided with opening 8 which is dimensioned in such a way that a pressure relief valve 13 can be positioned above reactor vessel 1 surrounding opening 8 of support plate 6. This creates a closed reactor space formed by reactor vessel 1 and opening 8. Normally, pressure relief valve 13 will be connected to support plate 6 by means of a screw connection 14.

In FIG. 7, an overview is given of an array containing 24 reactor vessels, each fitted with a pressure relief valve as described in FIG. 7. An array containing 24 reactor vessels 1′ is built up by holding means 3′ having openings through which the bottoms and tops of reactor vessels 1′ protrude. A support plate 6′ provides assistance in keeping the reactor vessels 1′ in place (using O-ring connection means (not shown)) and is fastened to the holding means by screw-threaded fasteners 7′. The reactor vessels are each fitted with pressure relief valves 13′.

The reactor vessels are kept in place by connection means which are preferably located in recesses in the surface of the holding means. Suitably, the connection means are in the form of gaskets. The recesses can have any suitable shape to fit the actual connection means. They may be tapered (in the direction of the openings), curved or profiled in order to match the actual connection means. Compressible materials, preferably also capable of deforming, can suitably be applied. For instance, rings of springs made of compressible materials such as rubbers or plastics can be applied but also metal rings of springs (e.g. made of copper or compressible alloys). Good results can be obtained by using so-called O-rings. Such rings are made of compressible and preferably deformable materials such as rubber and preferably protrude to some extent into the openings of the holding means in the absence of reactor vessels. When reactor vessels are placed within the holding means the O-rings will be retracted when inserting the reactor vessels to the extent that they will surround the openings holding the reactor vessels.

In order to provide the array with more rigidity, it is possible to use support plates which are placed on top of the holding means and which are fastened to the holding means by conventional fastening means such as screws, clamps of bands. In one embodiment, the support plate is a solid plate covering the total surface of the holding means and the tops of the openings in which the reactor vessels are fitted (their tops being on the same level as the surface of the holding means). In another embodiment, the support plate is provided with openings having diameters matching the diameters of the openings of the holding means so as to allow access to the reactor vessels for performing physical and/or chemical operations. From an accessibility point of view, it is preferred to have the diameters of the openings in the support plate matching the diameters of the openings of the holding means. From a support point of view, it is preferred to reduce the weight of the support plate by having a number of notches or holes in the support plate. They can be of any size and/or shape as long as they serve to provide adequate support.

It will be clear that the openings can have any suitable shape and need not necessarily to be circular; they can be of oval or lobed shape, though preference is given to circular openings. The holes through the holding plate can be perpendicular to the plane of the plate, or can be oblique. Preference is given to perpendicular of substantially perpendicular openings, in particular of cylindrical shape, as such an arrangement allows maximum flexibility.

An important aspect of operating an array of reactor vessels at elevated temperature and pressure is to be able to perform the desired operation(s) under leak-tight conditions. This can be achieved in the array system according to the present invention using the connection means together with a cover means which is removably fitted to the holding means, when use is made of a gasket, in particular an O-ring type gasket, which is dimensioned such that, in the absence of a reactor vessel, it protrudes to some extant above the surface of the holding means. When the reactor vessel is present in the opening and kept there by means of the O-ring, and a support plate and/or the cover plate (either solid or containing a septum of another form of closure) is present as well, a leak-tight sealing has been achieved.

As such, the support plate can serve as cover means to the extent that it effectively closes off the openings in the holding means in which the reactor vessels are fitted. Effective closing will also be achieved when use is made of a solid support plate (fastened as appropriate to the holding means) or by a support plate containing openings having diameters equal to or smaller than the diameters of the openings of the holding means they are matching, provided these openings are closed with materials operating as permeable (though leak-tight) seals for the top of the reactor vessels.

It is also possible in another embodiment of the apparatus according to the present invention to have a cover means (on top of the support plate) on top of the holding means. The cover means can be in the form of a solid plate but is preferably in the form of a plate as described hereinbefore, in particular with respect to the size of the openings. In a preferred embodiment, the apparatus according to the present invention has a cover means composed of a solid plate having openings the diameters of which match the diameters of the openings of the holding means, whilst septa covering the tops of the reactor vessels are present between the surface of the holding means and that of the cover means. In a further embodiment of the apparatus according to the present invention, the septa are located above the reactor vessel and between the support plate and the cover means so as to create a leak-tight volume composed of the reactor vessel and the openings within the support plate and the cover means, to the extent that the latter is neighbouring to the side of the septum facing the top of the reactor vessel.

The reactor vessel array according to the present invention can be operated at pressures in the range from 0 to 200 bar, preferably in the range from 0 to 50 bar, whilst maintaining leak-tight conditions. Operations can be carried out at ambient temperature (or below) and also at elevated temperatures depending on the type of operation envisaged. Those skilled in the art will know how to select the appropriate temperature and pressure conditions.

It is an important aspect of the apparatus according to the present invention (adding to its flexibility) that the cover means and, optionally, the support plate, can be provided with openings to allow certain physical and/or chemical operations to be performed. This is the case, not only in operations which can be carried out at normal (or elevated) temperature and at atmospheric pressure in open systems, but even more so in operations requiring closed, though accessible, volumes of reactor space.

For instance, the use of cover means provided with openings as defined hereinbefore allows performing certain types of physical and/or chemical operations either simultaneously or sequentially without having to disassemble the apparatus to a large extent or even at all. For instance, instead of a septum (which of course can act as a layer through which liquid(s) can be added or withdrawn), closure of the reactor vessel can be effected by means of a pressure relief valve which widens the window of opportunities, in particular with respect to carrying out reactions that require pressure. Other options which are possible within the concept of the top of the reactor vessel being covered whilst being capable of performing other duties comprise the presence of condensing means (thereby allowing, for instance, reflux-type operations being carried out in array systems), filtration means, manifolds and stirring means.

When stirrer means form part of the apparatus according to the present invention, they can be operated by means of shafts connected to a central motor so that the array is operated with the same stirrer speed and energy input for the individual members of the array.

The present invention also encompasses processes for performing physical and/or chemical operations to be carried out in an apparatus as envisaged by the present invention. Examples of physical processes which can be performed in the apparatus according to the present invention are mixing, centrifugation and evaporation.

When mixing is to be performed as a process using the apparatus according to the present invention as a means to carry out the process, use can be made of an orbital shaker, i.e. a piece of equipment designed to shake or rotate a number of reactor vessels at the same time. Such devices are commercially available and those skilled in the art will know when to apply such equipment.

Sometimes, the use of an orbital shaker, even at relatively high speed, is not enough to achieve the intended mixing operation. In such an event, it would be advantageous, in particular when dealing with rather viscous systems, to provide each reactor vessel in the array with an individual stirrer, for instance a rod-like stirrer, which will provide additional stirring capacity to the mixture being already in motion by operating the orbital shaker.

In another embodiment of the process according to the present invention, use is made of ultra-sound facilities to cause mixing in an array of reactor vessels. To that extent, the array of reactor vessels can be placed conveniently in a bath capable of producing ultra-sound. Such devices are known in the art.

In yet another embodiment of the process according to the present invention, the array of reactor vessels can be put as such in a centrifuge in order to perform a centrifugal operation. Likewise, the array of reactor vessels can be placed within a unit designed to evaporate, for instance by initiating and maintaining a reduced pressure in the unit in which the array has been placed.

Also heating and cooling are processes (which can be either of physical or of chemical nature) which can be operated smoothly when an array of reactor vessels is placed inside the appropriate equipment to carry out heating or cooling operations.

It will also be clear that several operations, for instance mixing and heating, can be carried out simultaneously, again adding to the flexibility of the system in accordance with the present invention. Those skilled in the art know which operations can be combined in order to obtain a better performance, time-wise or otherwise.

The apparatus according to the present invention will be operated in a similar way as far as the unit operations are concerned (mixing, heating etc.) but has, of course, the intrinsic capability that the operations to be performed within the individual volumes of the reactor vessels need not be the same. Therefore, the apparatus contributes to obtaining information form nearly identical, yet slightly different, process conditions, or, if desired, from rather different process conditions. It is also possible to have certain types of operations identical and others slightly, or even completely, different. Therefore, the apparatus according to the present invention can be instrumental in e.g. rapid catalyst screening but also in combinatorial chemistry. Many of the operations envisaged can be carried out by using robotic means as often practised in combinatorial drug synthesis and screening.

Although the invention has been particularly described above with reference to a limited number of specific embodiments, it will be understood by persons skilled in the art that modifications and variations are possible without departing from the scope of the claims which follow.

What is claimed is:

1. An apparatus for performing physical and/or chemical operations comprising:
holding means provided with openings for an array of reactor vessels;
reactor vessels positioned totally or partly within the openings; and
connection means capable of connecting the reactor vessels and the holding means, the connection means being located on or in the holding means surrounding the openings in which the reactor vessels are positioned, wherein the connection means are reinforced by the presence of a support plate containing openings having diameters substantially matching the diameters of the openings in the holding means and being removably fitted to the holding means.

2. An apparatus according to claim 1, wherein the connection means are located in recesses located in or at the surface of the holding means.

3. An apparatus according to claim 2, wherein the recesses are tapered in the direction of the openings.

4. An apparatus according to claim 1, wherein the connection means are gaskets composed of compressible materials.

5. An apparatus according to claim 4, wherein the connection means are in the form of O-shaped rings.

6. An apparatus according to claim 1, wherein the openings of the support plate match the openings of the holding means and further wherein the support plate has notches and/or holes to reduce the weight of the support plate.

7. An apparatus according to claim 1, wherein the connection means are in the form of gaskets which together with a cover means for the array of reactor vessels are capable of creating a leak-tight seal when the cover means is removably fitted to the holding means.

8. An apparatus according to claim 7, wherein the gaskets are in the form of O-rings which, together with a cover means for an array of cylindrical reactor vessels, are capable of creating a leak-tight seal when the cover means is removably fitted to the holding means.

9. An apparatus according to claim 7, wherein the cover means comprises a solid plate on top of the surface of the holding means.

10. An apparatus according to claim 9, wherein the cover means comprises a plate matching the openings of the holding means whilst the openings of the cover means are closed with permeable material.

11. An apparatus according to claim 7, wherein the cover means is composed of a solid plate having openings matching at most the diameters of the openings of the holding means whilst septa covering the tops of the reactor vessels are present between the surface of the holding means and said cover means.

12. An apparatus according to claim 7, wherein the cover means comprises a plate having openings having diameters matching at most the diameters of the openings of the holding means, the openings being provided with pressure relief valves.

13. An apparatus according to claim 7, wherein the cover means comprises a plate having openings having diameters of at most the diameters of the openings of the holding means, the openings being provided with condensing means.

14. An apparatus according to claim 7, wherein the cover means comprises a plate having openings having diameters matching at most the diameters of the openings of the holding means, the openings being provided with filtration means.

15. An apparatus according to claim 7, wherein the cover means comprises a plate having openings having diameters matching at most the diameters of the openings of the holding means, the openings being provided with manifolds.

16. An apparatus according to claim 7, wherein the cover means comprises a plate having openings having diameters matching the openings of the holding means, the openings being provided with stirrer means.

17. An apparatus according to claim 16, wherein the stirrer means are provided with shafts allowing them to be operated by a central motor.

18. An apparatus according claim 1, wherein reactor vessels are glass or steel reactor vessels.

19. An apparatus according to claim 18, wherein bottoms of the reactor vessels protrude through bottom of the holding means.

20. An apparatus according to claim 1, wherein the holding means are made of steel.

21. An apparatus according to claim 6, wherein the support plate is made of the same material as the holding means.

22. An apparatus according to claim 7, wherein the cover means is made of the same material as the holding means.

23. An apparatus according to claim 22, wherein the support plate or the cover means are made of the same material as the holding means.

24. A process for performing physical and/or chemical operations comprising:
providing holding means with openings for an array of reactors vessels;
positioning reactor vessels totally or partly within the openings; and
providing connection means capable of connecting the reactor vessels and the holding means, which connection means are located on or in the holding means surrounding the openings in which the reactor vessels are positioned, wherein the connection means are reinforced by the presence of a support plate containing openings having diameters substantially matching the diameters of the openings in the holding means and being removably fitted to the holding means.

25. A process according to claim 24, further comprising a mixing operation.

26. A process according to claim 25, wherein the mixing operation is performed by an orbital shaker.

27. A process according to claim 25, wherein the mixing operation comprises rod-shaped stirrers present in the reaction vessels during mixing.

28. A process according to claim 24, further comprising a mixing operation, wherein the mixing operation is performed by ultrasound to initiate and maintain mixing.

29. A process according to claim 24, further comprising a heating operation.

30. A process according to claim 29, wherein the heating operation is performed together with a mixing operation.

31. A process according to claim 30, further including a cooling operation.

32. A process according to claim 24, further including a centrifugal operation.

33. A process according to claim 24, further including an evaporation operation.
